(19) United States
(12) Patent Application Publication
(10) Pub. No.: US 2014/0316984 A1
(43) Pub. Date: Oct. 23, 2014

(54) MOBILE DEVICE TRANSACTION METHOD AND SYSTEM

(71) Applicant: INTERNATIONAL BUSINESS MACHINES CORPORATION, Armonk, NY (US)

(72) Inventor: Robyn R. Schwartz, Chicago, IL (US)

(73) Assignee: International Business Machines Corporation, Armonk, NY (US)

(21) Appl. No.: 13/865,093

(22) Filed: Apr. 17, 2013

(51) Int. Cl. G06Q 20/40

(52) U.S. Cl. CPC G06Q 20/4016; G06Q 20/40145
USPC 705/44

(57) ABSTRACT

A method and system involves using continual authentication and transactional information in a probabilistic framework to provide user and transactional authentication and authorization.

### FIELD OF THE INVENTION

This application generally relates to risk mitigation and, more particularly, to risk mitigation in payment transactions involving mobile devices.

### BACKGROUND

The use of mobile devices to effect payment or exchange value as part of transactions is becoming more and more prevalent, in the wholesale, retail and “peer-to-peer” environments. In addition to credit and mobile device initiated hard currency transfers, “digital money” or “e-Currencies” are being used more often in such transactions and, in many cases, as a convenience for transactions involving small amount transfers. Market forces are pressuring current banking systems to become more involved in such transactions, but such banking systems are presently ill-equipped to manage the escalating volumes of low-value transactions while concurrently minimizing risk (payor, payee and bank) from potentially fraudulent transactions and maintaining profitability.

### SUMMARY

One aspect of the invention involves a method. The method includes acquiring, over a period of time using at least a first component of a mobile device, first data representing behavior of an individual user and storing the first data in non-volatile storage. The method also includes acquiring, over a period of time using at least a second component of a mobile device, second data representing physical characteristic information relating to the individual user and storing the second data in the non-volatile storage. The method further includes, at about a time of a transaction involving the individual user and a payee: i) acquiring current behavioral data for the individual user using the first component, ii) acquiring current physical characteristic information for the individual user using the second component, iii) analyzing, using a processor, the current behavioral data relative to the first data to obtain at least one behavioral score, iv) analyzing, using the processor, the current physical characteristic information relative to the second data to obtain at least one physical score, v) fusing the at least one behavioral score and at least one physical score to obtain a fused present score, vi) applying at least one business rule to the fused present score, and vii) indicating to the payee that the transaction is to be approved or declined based upon a result of the applying in “vi)”.

Another aspect of the invention involves a computerized method performed as part of a transaction between a payor and a payee. The method involves receiving user information from a mobile device of the payor reflecting continuous authentication information for the payor; receiving transaction-related information from a device of a payee reflecting at least details of the transaction; retrieving from storage, at least one external score; applying at least one business rule to the user information, the business rule incorporating at least one threshold reflecting an acceptable level of business risk, the transaction-related information and the at least one external score to determine whether the transaction should be approved; and, if the at least one business rule is satisfied, approving the transaction.

Yet another aspect of the invention involves a system made up of an authorization and analysis unit having an interface through which the authorization and analysis unit receives continuous authentication data from an application program running on a mobile device of a user reflecting a continuous authentication analysis of the user over time, and programming, executed by a processor, which implements a probabilistic framework involving analyzing scores based upon (i) the received continuous authentication data, (ii) transaction related data and (iii) payee-related data, in connection with a current transaction between the user and the payee and determines, by applying at least one specified business rule to the scores, whether the transaction should be authorized and, if the transaction should be authorized, to trigger a payment system to effect a value transfer from an account of the user to an account of the payee.

The advantages and features described herein are a few of the many advantages and features available from representative embodiments and are presented only to assist in understanding the invention. It should be understood that they are not to be considered limitations on the invention as defined by the claims, or limitations on equivalents to the claims. For instance, some of these advantages are mutually contradictory, in that they cannot be simultaneously present in a single embodiment. Similarly, some advantages are applicable to one aspect of the invention, and inapplicable to others. Thus, this summary of features and advantages should not be considered dispositive in determining equivalence. Additional features and advantages of the invention will become apparent in the following description, from the drawings, and from the claims.

### BRIEF DESCRIPTION OF THE DRAWINGS

FIG. 1 illustrates, in simplified form, an overview of one example deployment arrangement suitable for use with the approaches described herein;

FIG. 2 illustrates, in simplified form, a functional representation of one example configuration for an authorization and analysis system as described herein;

FIG. 3 illustrates, in simplified form, an example model for one implementation of the authentication and scoring aspects as described herein;

FIG. 4 illustrates, in simplified form, a layout applicable to the use cases of FIGS. 5-9;

FIG. 5 illustrates, in simplified form, one example process by which a retailer can enroll a customer;

FIG. 6 is a simplified flowchart for one example use of the approach described herein to make a purchase using the configuration of FIG. 4;

FIG. 7 illustrates, in simplified form, one example of some specific processes that can be performed by the authorization and analysis system as part of Steps 604 and 608 of FIG. 6;

FIG. 8 is a simplified flowchart for another example use of the approach described herein to make a purchase using the configuration of FIG. 4;

FIG. 9 is a simplified flowchart for yet another example use of the approach described herein to make a purchase using the configuration of FIG. 4;

FIG. 10 is a simplified flowchart for a representative example of a transactional process in a peer-to-peer or non-traditional environment using one example implementation of the instant approach; and

FIG. 11 illustrates in simplified form, an overview of one example fusion scoring model.

### DETAILED DESCRIPTION

In simplified overview, through use of a system or method as described herein, the foregoing problems can be addressed. The systems and methods described herein can be used to allow transactions or value exchanges to occur while minimizing risk through continual authentication based upon a probabilistic framework incorporating simplified scoring to provide user and transactional authentication and authorization covering time periods before, during and after any particular transaction or value exchange event (such periods being collectively or individually referred to herein as “continuous” periods).

Advantageously, different implementations of the approach described herein allow users with smartphone devices and/or non-smart feature phones (i.e. those that, although not smart phones, have some level of internet and/or world wide web connectivity) to securely enter into a transaction with transactional authorization being performed in a passive manner, an active manner or some combination thereof, depending upon the particular needs and circumstances. Still further, through use of a simplified scoring approach, the payor, payee, and financial entity through which the transaction will be processed can be reasonably confident that the transaction is being entered in to by the person understood to be the registered end user.

Moreover, the simplified scoring approach can be used to minimize risk on both the payor and payee sides. For example, on the payee side, a specific transaction that defrauds a payee of a few cents may be inconsequential or even undetectable by itself, but a large number of such transactions from many different payors in aggregate could be devastating to the payee and/or the financial entity through which the transactions are processed.

To accomplish the above, implementations of the overall approach employ a combination of

1) continuing end user authentication,

2) determining individual transaction risk, and

3) determining cumulative transaction risk for the payee.

For definitional purposes, as used above and herein the terms “transaction” or “transactional” are intended to refer to any exchange of money (whether a sovereign currency like the U.S. dollar, a group currency like the Euro, a digital currency like Bitcoin, Ripple, Freicoin, Namecoin, (to name a few examples) or some other tender of ascertainable value) for goods, services, information (whether actual or virtual) or anything obtainable for value.

In addition, as used above and herein, the term “payor” is intended to refer to the entity who provides the money or value payment part of the transaction, whereas “payee” is intended to interchangeably refer to the entity that is the provider or the goods, services, information or other value (or in some cases their agent or an intermediary, like a broker) part of the transaction, bearing in mind that, for some complex transactions, an entity can be both a payor and a payee for a single “exchange” at different times. For example, if entity “A” wishes to obtain something from entity “C”, but does so through an intermediary entity “B”, “B” is potentially a payee with respect to “A” but a payor with respect to “C” if payment is made from “A” to “B” to “C”. As intended herein in that scenario, the dealing of entity “A” with entity “B” would be considered one “transaction” and the dealing of entity “B” with entity “C” would be considered a separate transaction (i.e. there would be two distinct transactions), whereas if payment is made directly from “A” to “C” (“B” intervened as an intermediary, but not with respect to passage of payment) the payment from “A” to “C” would be the only transaction, with “A” the sole payor and “C” the sole payee.

With this background in mind, different implementations of the mobile device transaction method and system will now be presented.

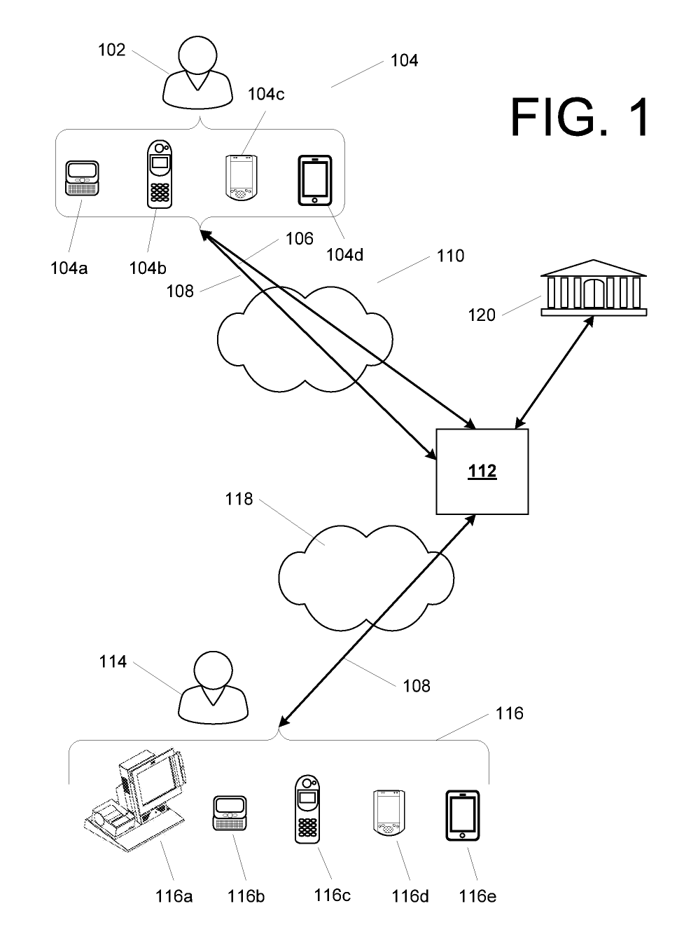

FIG. 1 illustrates, in simplified form, an overview of one example deployment arrangement 100 suitable for use with the approaches described herein.

As illustrated in simplified fashion in FIG. 1, in use, the arrangement 100 is made up of an end user/customer 102 who will enter into a transaction and pay using a mobile device 104, for example, a conventional feature phone 104a, 104b, a tablet or other mobile computing device 104c, or a smart phone 104d (ideally, the device 104 will be configured for wireless communication over both voice 106 and data 108 communication paths, although, depending upon the particular configuration, the approach can be implemented for devices 104 that can communicate over only one (for example a cell phone with cell but no internet access or a tablet with data communication capability (for example, according to the IEEE 802.11 standard) and no cellular voice capability), although certain benefits or advantages may not be available as a result).

Not it is also contemplated that the “mobile computing device” could encompass sensors proximate to the user that have limited or no processing capability as described herein, but pass the sensed information to another device (mobile or stationary) that would perform the processing functional aspects.

The device 104 connects via one or both paths through a mobile voice or data network 110, for example a cellular network or the internet, to the authorization and analysis system 112.

In similar fashion, the seller or intermediary 114 has a device 116 that at least has the capability for communicating wirelessly (typically via a cellular telephone network or data network conforming to the IEEE 802.11 standard). Depending upon the particular implementation, the device 116 could be a point-of-sale (POS) terminal or other computer device 106a, a feature phone 116b, 116c, a tablet or other mobile computing device 116d, or a smart phone 116e. The device similarly connects through a mobile voice or data network 118, for example a cellular network or the internet, to the authorization and analysis system 112. Depending upon the particular implementation and location, the networks 110, 118 through which the authorization and analysis system 112 is reached can, in whole or part, be the same or different networks.

In general, the communication paths 106, 108 and at least part of the networks 110, 118 are part of a communication system, for example a cellular telephone network implemented in accordance with, for example, any of the Global System for Mobile Communication (GSM), Code Division Multiple Access (CDMA), General Packet Radio Services (GPRS), Enhanced Data GSM Environment (EDGE) and/or Universal Mobile Telecommunications Service (UMTS) networks and standards, as well as any other third-generation (3G) and fourth-generation (4G, 4G LTE, WiMAX, HSPA+, etc.) networks and standards, in addition to future standards and networks which may be deployed to facilitate voice and/or data communication.

Note further that at least the user's mobile device 104 should have at least one, and preferably more, of the following features which, as will be described below, can be used to perform continuous authentication: a microphone, a keyboard, at least one camera, a global positioning satellite (GPS) receiver, a fingerprint or other biometric sensor (for example, for facial recognition, iris or retina scan, blood flow, blood vessel pattern or hand), visible light and/or infrared (IR) sensitive scanner or a multi-modal light sensor, inertial or movement sensor(s), or a touch screen or other surface for gesture or writing input. Thus, it should be appreciated that the instant approach relies upon and applies, in part, aspects of known techniques, for example, biometric authentication, facial recognition, in conjunction with existing devices, such as feature phones, smart phones and tablet computers, and their common components like cameras, displays, microphones, multi-protocol communication capability, etc. to advantageous effect. In this regard, for brevity, U.S. Pat. No. 6,983,882 and U.S. Pat. Pub. Nos. 2004/0218451, 2005/0273626, 2005/0030939, 2007/0245158, 2007/0155366, 2009/0327131, 2009/0204815, 2009/0327144, 2009/0119742, 2010/0291909, 2010/0215223, are incorporated herein by reference in their entirety as if fully set forth herein.

Similarly, as will be appreciated from the description herein, the instant approach also applies, in part, various known principles of continuous authentication, for example as described in Traore, Issa et al., “Continuous Authentication Using Biometrics: Data, Models, and Metrics,” IGI Global (2012)(ISBN-9781613501290) to achieve a score representing, in some manner, the degree of confidence or likelihood that currently captured user information corresponds to past user information.

Returning to the system of FIG. 1, the authorization and analysis system 112, which is described in greater detail below, is generally owned by or affiliated with a bank or other financial institution 120 which operates to actually effect a funds transfer from payor to payee.

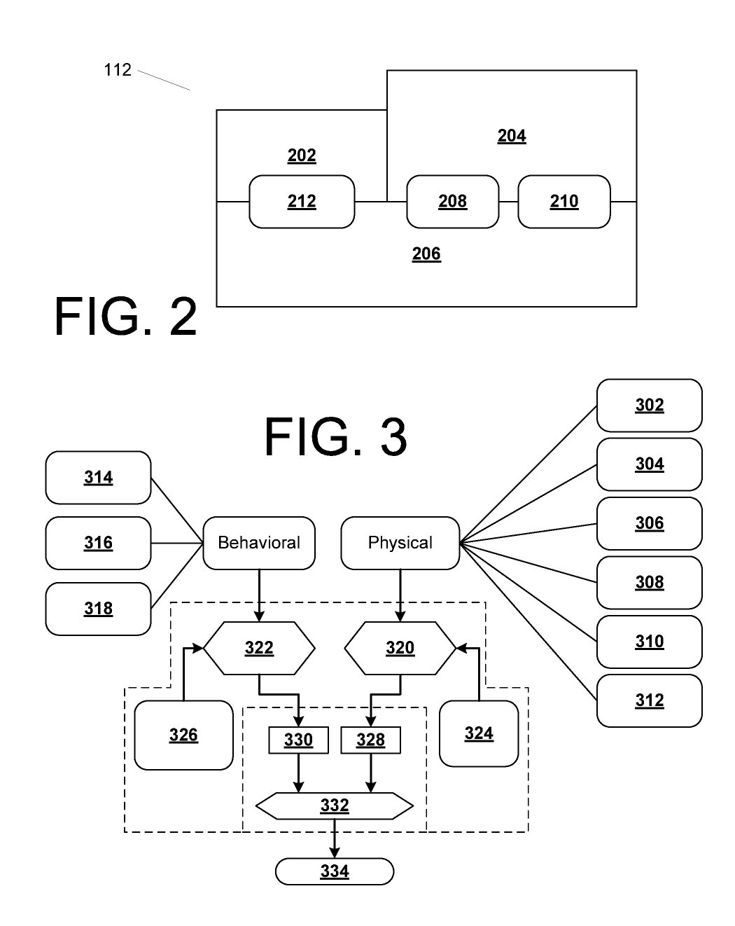

FIG. 2 illustrates, in simplified form, a functional representation of one example configuration for an authorization and analysis system 112 as described herein.

From a hardware standpoint, the authorization and analysis system 112 is made up of one or more computers (having one or more processors) and configured with appropriate memory (RAM and ROM), program and data storage, input/output (I/O) and other capability as needed or desired for the particular implementation. The processor(s) operate under stored program control to execute one or more application programs that implement or facilitate operation of the functions or tasks to be performed by the authorization and analysis system 112 as described herein. Stored program control includes operating system software, application programs, code components and/or software modules that control operation of the authorization and analysis system 112. For example, the authorization and analysis system 112 can include program code that formats and analyzes biometric, location, context information received from sensors of the user's phone 104 as well as executing program code to implement and perform the comparisons, apply rules, and/or calculate scores, as well as to “learn” and store combinational patterns of user activity for use in future analysis and score development. The processor may also execute other programs or software applications stored in the program storage to perform ancillary tasks as needed or desired, such ancillary tasks being unimportant to understanding the invention.

As shown, the authorization and analysis system 112 architecture is made up of three major functional components, a mobile access component 202, a decision management and data mining & analytics component 204, and a security services component 206. As configured, these components 202, 204, 206 interact to provide, for example, the risk-based authorization 280 and fraud detection 210 described below, as well as other appropriate authentication 210, for example, continuous authentication of a user. Specific representative examples of products suitable for implementing the foregoing include, but are not limited to, the IBM® Worklight server for the mobile access component 202, the IBM® WebSphere® Multichannel Bank Transformation Toolkit for the decision management and data mining & analytics component 204, and IBM® Tivoli® Endpoint Manager and IBM® Tivoli® Security Identity and Access Manager for the security services component 206.

The mobile access component 202 operates as the primary external interface of the authorization and analysis system 112 to communicatively interact with the payor's device 104 and the payee's device 116 via the network(s) 110, 118. This component receives information, for example, from the payor's device 104 (and possibly the payee's device 116) on a regular basis so that it can be analyzed as part of a continual authentication process.

The decision management and data mining & analytics component 204 analyzes information received from the payor and possibly payee's devices 104, 116 as well as stored information relating to past actions of one or both to identify patterns reflecting possible risk or fraud. The decision management and data mining & analytics component 204 works in conjunction with the security services component 206 to, for example, develop a continuing risk score for the payor, a continuing risk score for the payee, and a current transaction risk score for the particular transaction being undertaken by fusing the results of various analyses. Rules are then applied to one or more of these risk scores, either individually, in some combination with each other, or in conjunction with other information to reach a determination regarding whether the transaction should be authorized.

For example, a user may be engaging naturally in conversations proximate to their mobile device (using, or nearby to, the device). These conversations are tracked by the device, not for content, but with intent of capturing and verifying a continual perspective, or a rating, on the “authentication” of that user based on voice, for example, sound level, quality and language. At any point then, using that information, one or more polled, physical characteristic related, scores can be assembled that represent a view of current “moment in time” authentication of the user, through comparing that captured information against prior information for some period of time before that point.

In addition (or alternatively) user may also be carrying their mobile device while they proceed through their normal courses of action, for example, as they go to work or shopping. In doing so, they may follow a similar, routine journey path (e.g., mass transit routes and or times, driving route or times, etc). This normal course of behavior can similarly be used to generate an “authentication” score that at any point can offer a polled behavior-related score assembled that represents a view of “moment in time” authentication based upon behavior against behavior(s) for some period of time before that point in time.

Again, in addition or alternatively, the user might purchase a cup of coffee most days from a specific vendor, i.e. they have typical of repeated behavior in terms of the point of purchase, time of purchase, cost of purchase, item(s) being purchased, etc. Such behavioral activity can also be tracked such that, at any point, a polled score representing that aspect of the user's behavior can be assembled representing a view of that moment in time which can be used for “authentication” against behavior for some period of time before that point.

Note here that, in some implementations, functional aspects of the decision management and data mining & analytics component 204 and security services component 206 can advantageously be distributed to user devices (i.e. an application program running on the user device) so that those aspects will be performed on the user's device as opposed to in the system 112, with the output of the application program, which may be scores, raw sensor data and/or other information, being passed to the system 112 as required for use or further analysis.

Still further, scores can be developed on the payee side as well based upon, for example, transactions with particular payors, involving specific goods or values, within a specific time window, etc., as well as among multiple payees. Advantageously, this can be used to detect possible fraud or other law violations, for example bypassing reporting requirement for certain transaction amounts, because it can be used to detect a single user engaging in multiple non-reportable level transactions (which, in aggregate, exceed the required reporting level) with multiple related vendors, as well as transactions in which many, seemingly unrelated, people engage in a coordinated way to enter into non-reportable level transactions with a vendor (or a few related vendors) which, seen in aggregate, would be suspicious as seeking to avoid such reporting. For example, implementations of the approach described herein could be used to detect a “flash mob” type coordinated action to undetectably transfer $100,000 to someone by having 1000 of the people in the “mob” each concurrently make phantom $100 purchase transaction with that person or a group of vendors affiliated with that person.

The scores representing a user's behavioral, biometric, and/or physical characteristic information, for example as reference above, can be synthesized against a probabilistic framework to arrive at a simplified few scores or single score representing a then-present level of risk. This characteristic information or scores can then be combined (“fused” or “fusing”) within the framework, which provides a relative value to all the collected and included metrics or scores. Thus, the fused or synthesized score(s) represent an aggregate simplified view of the specific user at that time, as mandated by the relative weight and balance of all such scores. In other words, the fused or synthesized score will reflect a “moment in time”-specific simplified representation of the then-present “state of affairs” relating to a specific transaction and its associated risk (for a given transaction or exchange event, to the payee, and/or the payment system) that can be measured against specified business rules to determine acceptance or rejection of a given transaction or exchange event.

Moreover, the use of a probabilistic framework provides weight and balance to the overall analysis, based on applicable business rules and intentions. For example, in certain instances, business rules may specify a significantly higher weight be afforded to biometric or physical characteristic-related authentication scores as opposed to behavioral characteristic-related authentication scores. In other instances, all scores may be weighted fairly equally under the applicable business rules. In still other instances, the different scores can be analyzed according to more complex formulas or algorithms that involve, for example, levels of conditions, the outcome of which will determine whether a given transaction will be allowed or not. Advantageously, one or more different business rules can be established (generically or specifically) for different: circumstances, payors, payees, transaction types, times, locations, items, value, etc., involved. Still further, advantageously, an event indicating a poor authentication score at a point in time could potentially be used to disqualify or validate a prior transaction or exchange event or some future transaction or exchange event, based on applicable business rules and the liability particular entities are willing to assume.

More specifically, underpinning the operation decision management and data mining & analytics component 204 is, in part, the use of some type(s) of continual authentication based, in part, upon the capabilities of the user's particular mobile device, so as to confirm the user's “authenticity” so that, when the user begins a transaction there is no need for specific authentication, like a log-in or password, that does little to minimize risk because they can be more easily “hacked”, stolen or falsely replicated.

The concept behind continual authentication is to (on an ongoing, short schedule fashion) poll to ascertain personal identity information and to analyze interactions and context which, in combination, allow one to achieve implicit end user authentication. The advantages of this approach, as opposed to log-in type approaches are: continuity of user experience—i.e. no “stop” to log-in then “go” to transaction request, multi-factor based authentication which can be more reliable and is less easily fooled than a simple log in approach, and the ability to stop a transaction, mid-stream, if a new or other than expected user is identified or is circumstances indicate a higher than acceptable risk condition exists. For example, the system 112 may be aware that particular users get paid monthly at mid-month and, therefore, for a specific user score, may allow a transaction occurring right after “pay day” to be approved, by deny it if made a week after “pay day” if there is a significantly higher risk that the person will be over-extended at that point inn time. Thus, with the instant approaches, the transaction or exchange event is wrapped in rule-based user authentication, and is therefore less risky.

The instant continual user authentication aspect is, depending upon the particular implementation, achieved through gathering of varying levels of biometric and/or other behavioral or contextual information in an ongoing fashion through either series of applets and/or a multi-layered application running on a user's mobile device, for example, as shown and described in commonly assigned U.S. patent application Ser. No. 13/345,932, the entirety of which is incorporated herein by reference.

In doing so, the collected information is used for continual verification of the identity and authentication of the user, as opposed to, traditional “stop-n-go” means of identification (e.g. “what you know” and “what you have” methods). The instant approach leverages techniques as voice, speech behaviors or conversational biometrics, gesture, fingerprint, video, context, shopping behaviors, etc) to build up a profile of the user made up of user characteristics (physical and behavioral) against which future actions can be compared to continually verify the user's identification. In this way, when the user becomes the payor in a transaction, the transaction can proceed more quickly and seamlessly since that user is authenticated on an ongoing basis.

Moreover, additional characteristic information can be gathered relating to the specific transaction and/or the interaction of others with the same payee to further minimize risk on a multi-transaction basis. Thus, depending upon the particular implementation, business rules can further be used for transaction- or payee-related “layers” of authentication (e.g. related to product(s), context, price, shrinkability, etc.)

Depending upon the particular implementation, the continual end user authentication can be based upon permutations and combinations of any number of factors that can be obtained using the mobile device, for example:
voice—authentication via sound/quality registration & verification (pitch, tone, quality, etc.),
speech behaviors—authentication against known speech mannerisms (e.g. verbiage, speed or inflection patterns, etc.),
gesture or fingerprint—authentication via known and recorded gesture-based actions representing a user's “signature”,
video—authentication via pre-recorded image or data analysis against periodic face, iris or retinal scans,
recurrent action—authentication based upon frequency, timing or destination of calls made and/or messages sent to particular parties and/or content similar to speech behaviors,
location/context—authentication via comparison of current location, timing, etc. to prior context (known “shopping” habits to include location, time, etc),
shopping behaviors—authentication via known or understood patterns of shopping behavior to include such parameters as replenishment SKU's, brands, sizes, purchase timing behaviors, etc., and
other information that can be gathered on an ongoing or periodic basis and forms a user-indicating pattern against which future action can be compared, including typing speed or style or other input behavior, mobile device movement patterns (as detected by mobile device inertial sensor(s)), etc.

In this manner, by merely having and using their own device, the end user is largely passive in their participation in the authentication process, other than by being in proximity to their own device and using it in their normal manner (e.g. authentication can occur non-intrusively during normal usage such as while the user is engaged in a conversation via voice or txt, looking at something on the device screen, or simply carrying the device physically on their person, etc.) The idea being that end user authentication is ongoing so that when a user needs to engage in an activity in which traditional log-in or other authentication would otherwise be required, for example, a purchase transaction, a private information request transaction, etc.) they can proceed directly to the secure processes of the transaction itself without interruption to log-in because they are continually being verified, based upon analysis of the appropriate mix of the foregoing factors, as being who they purport to be.

Stated another way, the system 112 gains an understanding of key behavior and physical patterns of the user (and, in some cases, the payee) either through direct input or based upon occurrences over time because patterns are continually developed and analyzed as usage increases and time passes. Still further, as alluded to above, applicable data can be obtained from the user's mobile device, as well as other devices with which that user may be interacting if those other devices are configured to provide such information to the system 112. For example, if a user, having a feature or simple phone, interacts with another user having a smarter phone or device, and both are registered with the system 112, then applicable authentication data can be gathered from the user having a smarter phone or device for both users and, thus, can be added to the overall view of the user who only has the feature or simple phone. By way of more specific example, if a customer in a retail environment were to interact with a merchant via the customer's feature phone and the merchant's smart phone, applicable data related to that interaction can be obtained via the merchant's phone and, for example, be applied to the customer in support of that customer's end user authentication.

Depending upon the particular implementation, the continual authentication can be managed and provided (for a given user), predominantly at the user's device level for periodic validation by the online system 112 or, in some implementations, it can be managed by mere passing of information gathered using the user's device (and possibly one or more other devices) to the online system 112 for compilation and analysis.

In this manner, different security levels can also be specified so that, based on the particular security levels as predefined or defined dynamically by a business entity, the system 112 can validate the user at a given point in time against selected patterns of known, understood, or predicted information for that user. To do so, the system 112 generates a dynamic score to which business rules or defined score criteria are applied in order to determine whether or not to accept the user as authentic and/or if a particular transaction should be allowed to proceed. If the score is within an “acceptable” range (as defined by the rules or score criteria) then the transaction (interaction which would require end user authentication) can be allowed and, if not, it can be blocked or prevented.

FIG. 3 illustrates, in simplified form, an example model for one implementation of the authentication and scoring aspects as described herein. As shown in FIG. 3, multiple pieces of user-related physical information 302, 304, 306, 308, 310, 312 are collected on a recurring basis using sensors or components of (or associated with) the user's device 104, for example two or more of: spoken voice information, a retinal scan, a facial scan, gesture(s) or finger movement information, fingerprint and/or body temperature. Similarly, multiple pieces of user-related behavioral information 314, 316, 318 are collected, for example one or more of conversational action information, location information, behavioral patterns and context information.

The collected information is, depending upon implementation, aggregated in the user's device 104 or passed periodically in un-aggregated form to the authorization and analysis system 112. “Pattern check” programs, applets or functions 320, 322 are then used to check the collected physical information 302, 304, 306, 308, 310, 312 and behavioral information 314, 316, 318 against stored physical patterns 324 and stored 326 behavioral patterns of that user collected (and analyzed) over time. Depending upon the particular implementation, the pattern check programs, applets or functions 320, 322 can be wholly present on the user's mobile device 104, wholly within the authorization and analysis system 112, or require interaction of the two. In either case, the results of the physical pattern checks 320 are fused into a single physical score 328 and the results of the behavioral pattern checks 322 are similarly fused into a single resulting score 330, each score 328, 330 representing, the degree of match or certainty with which the present information correlates with the stored pattern information 324, 326 and, thereby allowing an inference to be drawn as to whether (based upon the gathered information) the user is who they purport to be. Thus, by doing so on a continuous basis, at the time of a transaction, the then-current scores 328, 330 can be compared against a threshold 332 appropriate for or applicable to the particular transaction such that a “Go/Nogo” decision 334 can be made with respect to that transaction.

Having described the components of systems employing the approaches described herein and their operation, various examples of how interactions occur during use of an example implementation will now be described.

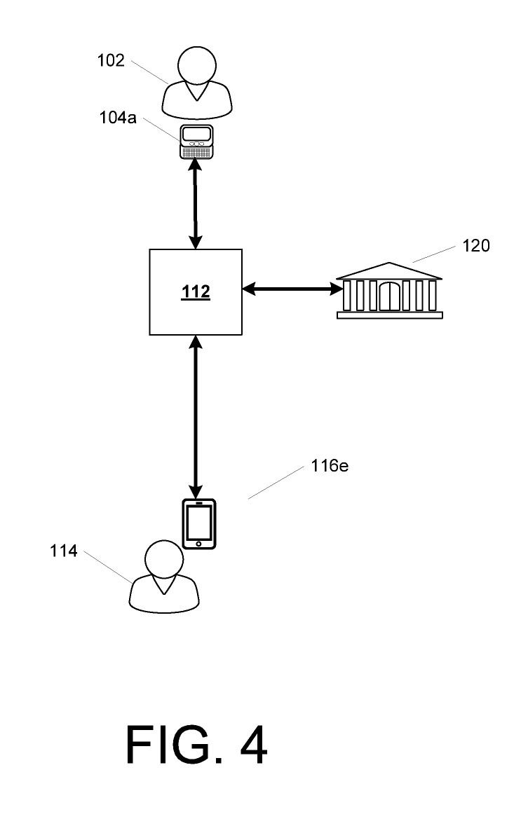

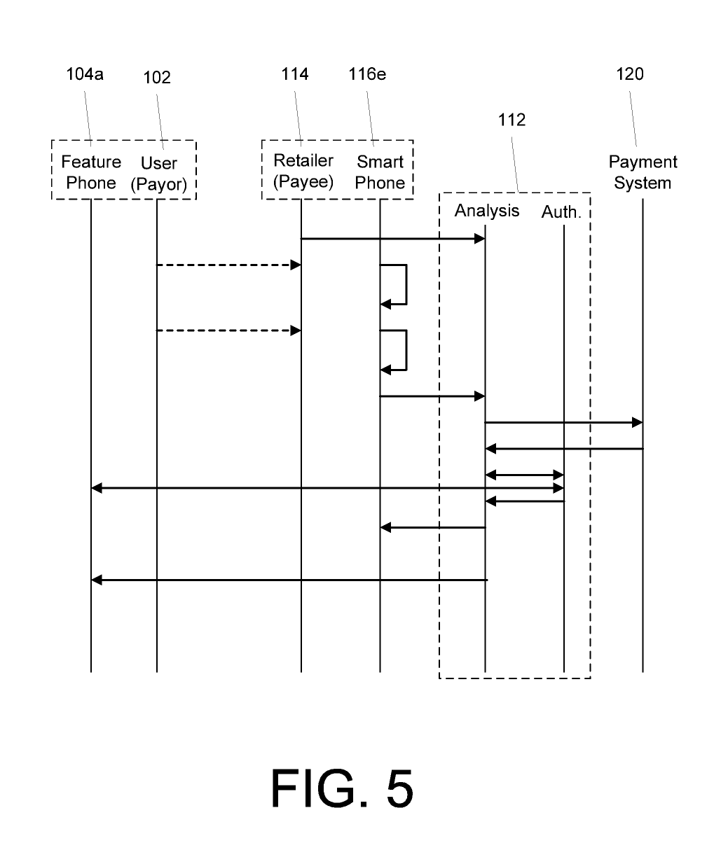

FIG. 4 illustrates, in simplified form, a layout applicable to the use cases that follow in FIGS. 5 through 9. As shown, a customer 102 equipped with a feature phone 104a will interact with a retailer 114 who is equipped with a smart phone 116e for purposes of various transactions. The transactions will be handled by an example authorization and analysis system 112 as described herein that, in this example, is owned by a bank 120 that processes payments.

Now, with continuing reference to FIG. 4, FIG. 5 illustrates, in simplified form, one example process 500 by which a retailer 114 can enroll a customer 102 so that future electronic payments can be made via an approach as described herein. The process begins with a retailer 114, who is already enrolled as a payee, logging in to the authorization and analysis system 112 (Step 502) using their smart phone 116e.

At some point thereafter, a customer 102 arrives and decides to enroll (Step 504). Using an app running on the smart phone 116e, the retailer 114 requests certain information from the customer 102 to add them as a new payment customer (Step 506). The customer 102 provides the requested information (Step 508), for example, their cell phone number and other information, for example, if they already have an appropriate mobile banking account, the account-identifying information and/or information relating to the specific model of the customer's 102 phone and/or its capabilities. That information is similarly entered by the retailer 114 (Step 510). Next, the retailer 114 contacts the authorization and analysis system 112 to register the customer 102 (Step 512). The authorization and analysis system 112 runs a check to ascertain whether the customer has an existing account with the payment system 120 (Step 514) and, if it does, it associates that account as the usage account but, in this example, we presume that the customer does not have one, so the payment system 120 creates one and provides a mobile account identifier for this new customer account back to the authorization and analysis system 112 (Step 516). The authorization component 206 then interacts with the analysis component 204 of the authorization and analysis system 112 to perform the appropriate internal new user set up for this customer 102 (Step 518) and, since the customer 102 has a feature phone 104a, initiates a voice call to the customer 102 (Step 520). In this example, one of the pieces of information used for continuous authentication is voice print, so the customer is prompted to speak some phrase, for example, “Please establish a pass phrase by speaking a sentence of your choice” or “Please repeat back the following phrase(s)” so that a sufficient initial voice recording can be obtained. Note here that, as part of the process, the customer 102 will be required to produce certain identification to establish who they are. Thus, it is important that the customer 102 provide the initial voice to the system 112 in the presence of the retailer 114, so that the system has initial assurance that the person speaking is the person corresponding to the identification information provided by the customer 102. The authorization component 206 then interacts with the analysis component 204 to store the voice information as the initial stored biometric information (Step 522). Depending upon the initial features of the customers 102 phone 104, additional initial biometric information may be gathered in similar fashion as well.

When this initial set up is complete, the system 112 communicates back to the retailer's smart phone 116 that the registration process is complete (Step 524) for transactional purposes and the system 112 also interacts with the customer's 102 phone 104a to install the appropriate application so that information gathering for the continuous authentication can begin (Step 526). Note here that these last two steps could have occurred in a different order, concurrently, or in a partially overlapping manner. Note further, as an alternative, the retailer 114 could provide the phone 104a that will be used thereafter to the customer 102 as part of the registration process, in which case some of the steps may have been performed in advance and the application might already be installed but not activated until assigned to a particular customer. In addition, it is important to note that, although the above example involves the mobile device the user already has, in some implementations, the mobile device can be one provided as part of the registration process. Moreover, although described in connection with certain mobile devices 104, 116, it should be understood that any mobile device capable of performing the functions described herein, whether a general purpose device like a phone or tablet computer or a special purpose device designed specifically or predominantly for operation consistent with the purposes described herein, is to be considered a mobile device 104, 116 as referred to herein.

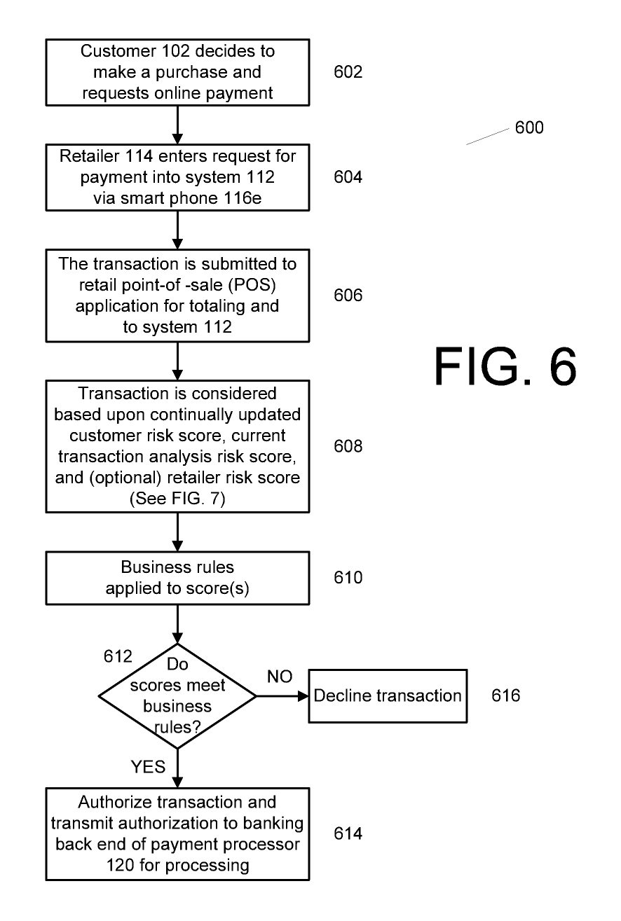

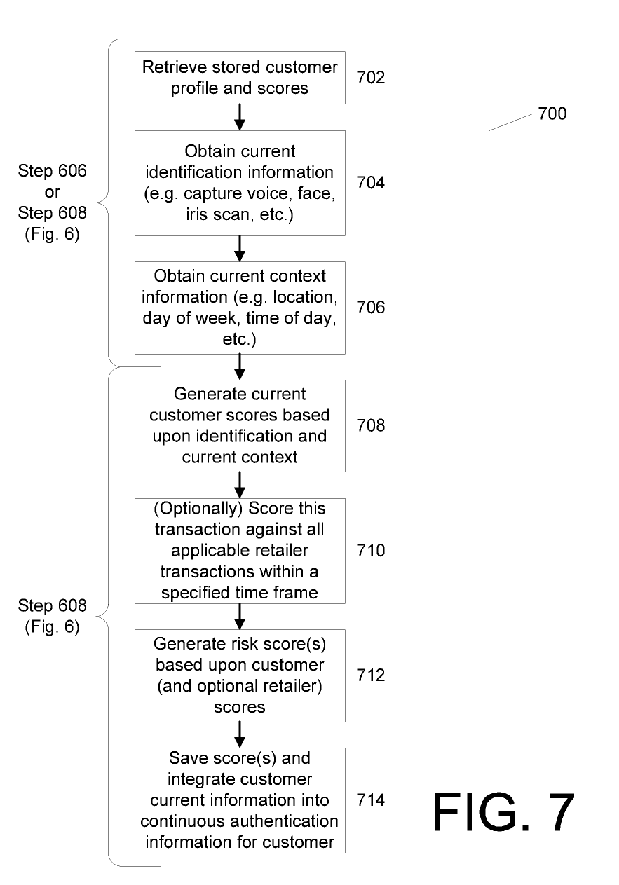

FIG. 6 is a simplified flowchart 600 for one example use of the approach described herein to make a purchase using the configuration of FIG. 4. Note that this process presumes the customer 102 and retailer 114 of this example are already registered and have an account established for this purpose.

The process begins with the customer 102 deciding to make the purchase and requesting to pay the retailer via an online approach as described herein (triggering a communication between the customer's phone 104 and the system 112) (Step 602). In response, the retailer 114 uses their smart phone 116e to enter the request for payment into the system 112 (Step 604). This causes the system 112 to match the customer 102 to the retailer 114 for this transaction, to expect further input from the retailer 114, and to retrieve the appropriate score records for the customer 102 (and optionally the score records for the retailer 114 as well). The retailer enters the transaction into their POS application for totaling, and the appropriate information is similarly submitted to the system 112 (Step 606). Depending upon the particular implementation the retailer 114 is using, this may involve just sending the grand total for the transaction, or it might involve also sending other transaction specific information, by way of example, the SKU or other identification information for the things purchased, unit quantity information (i.e. 1 package of cookies or 3 packages), coupon related information, etc.

The system 112 retrieves the stored scores for the customer 102 reflecting the continuous physical and behavioral authentication information, the optional retailer 114 risk score and the current transaction analysis risk score (Step 608). Presume for purposes of this example, the continual authentication score is a 93 (reflecting about a 93% certainty that the present customer is who they purport to be) and the current transaction score is an 82 (reflecting a transaction that has about an 82% correspondence with prior transactional behavior). Next, the business rules are applied to the scores by comparison of the scores to one or more threshold(s) (Step 610). Purely for purposes of this example, presume that business rule requires the customer threshold to equal or exceed a score of 85 and the transaction threshold score exceed a score of 80.

Thus, if the actual scores all meet the business rules (Step 612), the transaction will be authorized and the payment processor 120 will be directed to effect the payment transfer. Of course, if one or more of the business rules were not met (Step 612), the transaction would be declined (Step 616).

Note here that the business rules can be simple rules, such as a single threshold number against which a single fused score can be applied, or they can be more complex. For example, a more complex business rule might be: if the transaction score is above “x” but below “y” AND the continuous authentication score is greater than “a” then approve, but if less than “a” decline, and if the transaction score is above “y” and the continuous authentication score is less than “a” but still above “b” approve, but if below “b” decline. An even more complex business rule might be: if the user authentication score is above a particular threshold, compare the instant transaction score against other transaction scores involving the same items and other retailers of the same goods within a one month window and, if the scores are all the same, decline, but if the transaction scores are all above another threshold and the values of the transactions, in aggregate are all below a specified value, approve the transaction, any otherwise decline. Thus, the business rules can be as simple or complex as appropriate or needed for the particular circumstance and need not entirely relate to the specific transaction.

FIG. 7 illustrates, in simplified form, one example of some specific processes that can be performed by the system 112 as part of Steps 604 and 608 of FIG. 6. For example, as shown in FIG. 7, as part of Step 604, the system 112 could retrieve the stored customer profile and customer-related score(s) (Step 702) and obtain current physical information regarding the customer (Step 704) using the capabilities of the customer's phone 104a, for example, biometric information, as well as appropriate behavioral and context related information (Step 706). Of course, alternatively, Steps 702 through 706 could be performed as part of Step 608 of FIG. 6.

In addition, the system 112 could generate current scores for the customer 102 based upon the current information obtained (Step 708). Alternatively, if the customer's phone 104a had sufficient capability, this step could be done on the customer's phone 104a and the phone 104a would then merely pass the result of that generation to the system 112.

On the retailer side, the system 112 may also optionally score the present transaction against all applicable transactions within a given time period involving that retailer 114, or similar transactions of this customer with other retailers, in order to, for example, potentially detect small value but high volume fraud (Step 710).

Using the information, the system 112 will generate risk scores (Step 712) reflecting certain risk if the transaction is approved or declined, for example, potential loss of business from that customer or to that retailer for the transaction due to poor customer experience if transaction is declined, cost of the lost transaction, aggregate cost of loss to retailer over a specified period of time if the customer is a regular customer and never returns thereafter as a result of transaction being declined, likelihood that customer will become a repeat customer, etc.

Finally, the system 112 will save the various scores in the respective customer (and optional retailer 114) profile and (if the system 112 maintains the stored information 324, 326) updates the stored information by integrating the current customer information into it (Step 714).

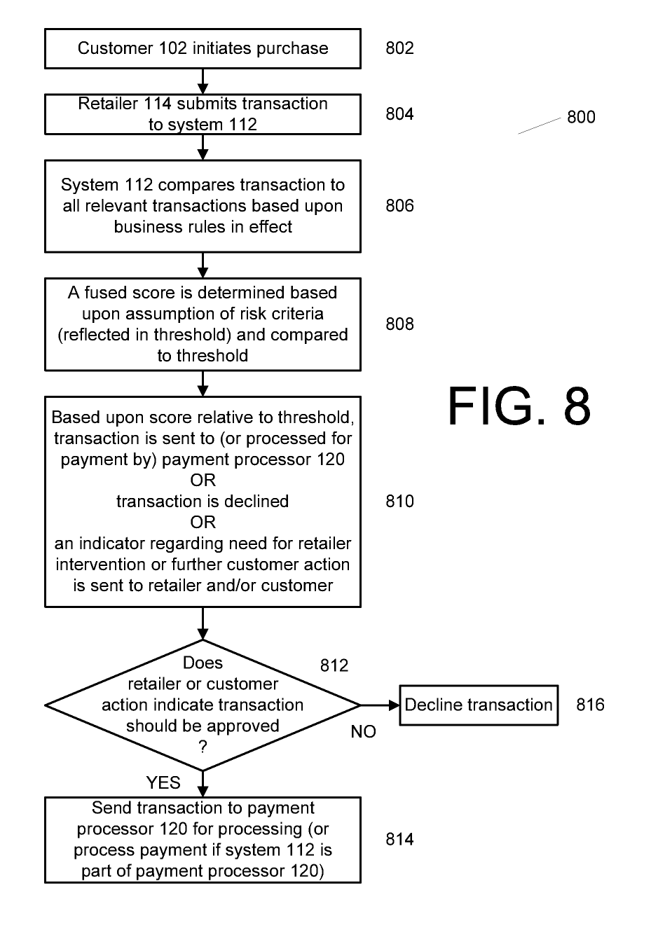

FIG. 8 is a simplified flowchart 800 for another example use of the approach described herein to make a purchase using the configuration of FIG. 4. Note that this process also presumes the customer 102 and retailer 114 of this example are already registered and have an accounts established for this purpose.

This purchase process begins with the customer 102 initiating the purchase (Step 802). The retailer 114 then submits the transaction to the system 112. The system 112 compares that transaction to all relevant transactions for this retailer 114 (or related retailers) based upon specific business rules in effect (Step 806). Based upon “assumption of risk” criteria (i.e. those reflecting whether (and to what extent) risk should be allocated among the customer 102, retailer 114 and/or payment processor 120, a fused score is calculated and compared to one or more thresholds (Step 808). Depending upon the result of that comparison, the transaction is either processed for payment, declined or an indicator is sent to the retailer 114 and/or customer 102 indicating that further action may be required before the transaction can be authorized (Step 810). In the latter case, depending upon the particular implementation, this can involve, for example, requiring the customer to provide some additional biometric information, like a fingerprint or iris scan via the retailer's phone 116e (because the user's phone 104 lacks such capability), or present some other information that can be verified by the retailer 114, like a picture driver's license or passport. Further communication thereafter by the customer 102, retailer 114 or both may then occur with the system 112 using that additional information to determine whether or not the transaction should be approved (Step 812). If the information meets whatever requirement is in effect, the transaction can be processed by the payment processor 120 (Step 814), and, if not, the transaction can be declined (Step 816).

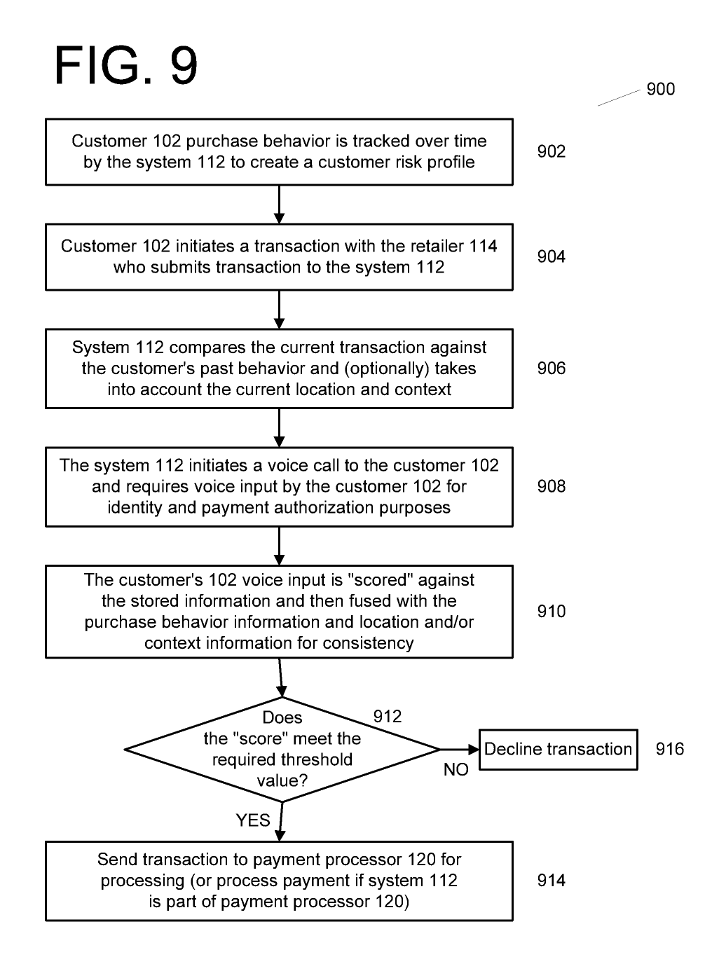

FIG. 9 is a simplified flowchart 900 for yet another example use of the approach described herein to make a purchase using the configuration of FIG. 4. Note, this process similarly presumes the customer 102 and retailer 114 of this example are already registered and have an accounts established for this purpose.

With the example of FIG. 9, the customer's purchase behavior is tracked over time by the system 112 resulting in creation of a customer risk profile (Step 902). At some point thereafter, the customer 102 initiates a transaction with the retailer 114 who submits the transaction to the systems 112 (Step 904). The system compares this new transaction against the customer's prior tracked behavior and (optionally) also takes into account current location and context (Step 906). With this implementation, the system 112 then initiates a voice call to the customer 102 which requires voice input by the customer 102 by responding to, for example, “state your pass code”, “please repeat the following phrase”, “state the name of the retail establishment where you are right now”, “please answer this question”, or the like, which is used for identity and payment authorization purposes (Step 908). The customer then provides the requested voice input, which is scored against the stored information and then fused with the purchase behavior information and (if applicable) the location and/or context information for consistency (Step 910). If the fused result meets a pre-specified threshold value (Step 912), the transaction is authorized and processed for payment (Step 914). If not, the transaction is declined (Step 916).

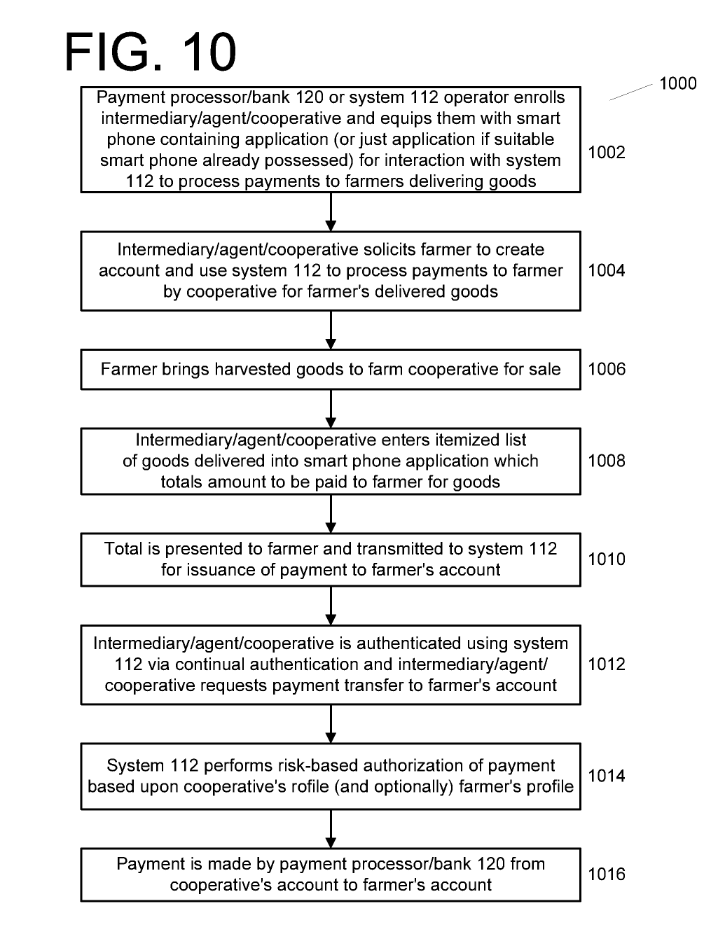

Having discussed the instant approach using several different retail environment examples, it should be noted that, advantageously, the instant approach is not so limited. Rather, by its very nature, it is suitable for use in a peer-to-peer environment and/or other non-traditional circumstances where the payee does not typically receive payments in the manner retail establishments do, for example when a customer uses a credit, debit or charge card. To better illustrate this advantage, FIG. 10 is a simplified flowchart for a representative example of such a process 1000 in a peer-to-peer or non-traditional environment using one example implementation of the instant approach. Specifically, the example of FIG. 10 presupposes usage in a farm cooperative environment in which farmers sell their goods to the cooperative, which, in turn, will provide those goods to others on a subscription, wholesale or retail basis. Thus, with respect to the interaction of the farmer and the cooperative (represented in FIG. 10), the farmer is the payee.

In this scenario, the process 1000 would begin with, for example, the payment processor/bank 120 (or potentially the entity that provides the services of the system 112) enrolling the cooperative (or an appropriate intermediary or agent) and establishing an account for processing payments by the cooperative to farmers for their goods (Step 1002). In conjunction with enrollment, the intermediary/agent/cooperative may be provided with a smart phone containing the application usable to interact with the system 112 or, if they already have a suitable smart phone, just the appropriate application.

At some point in time thereafter, the intermediary/agent/cooperative solicits the farmer (and gets farmer to enroll) to receive payments from the cooperative for the farmer's goods using the system 112 (Step 1004).

Thereafter, at some point the farmer delivers goods to the cooperative (Step 1006). Upon delivery, the intermediary/agent/cooperative enters an itemized list of the goods into the smart phone application, which totals the amount to be paid to the farmer for those goods (Step 1008). The total is presented to the farmer and transmitted to the system 112 for issuance of payment for the goods to the farmers account (Step 1010).

The intermediary/agent/cooperative is authenticated using the system 112 via continual authentication and the cooperative requests payment be made to the farmer's account for those goods (Step 1012). In turn, the system 112 performs risk-based authorization of payment based upon a comparison of the specific transaction against score information in the cooperative's stored profile and, optionally, in conjunction with the farmer's profile (Step 1014). If the appropriate threshold(s) are met and/or business rules are satisfied, payment is automatically made from the cooperative's account to the farmer's account (Step 1016).

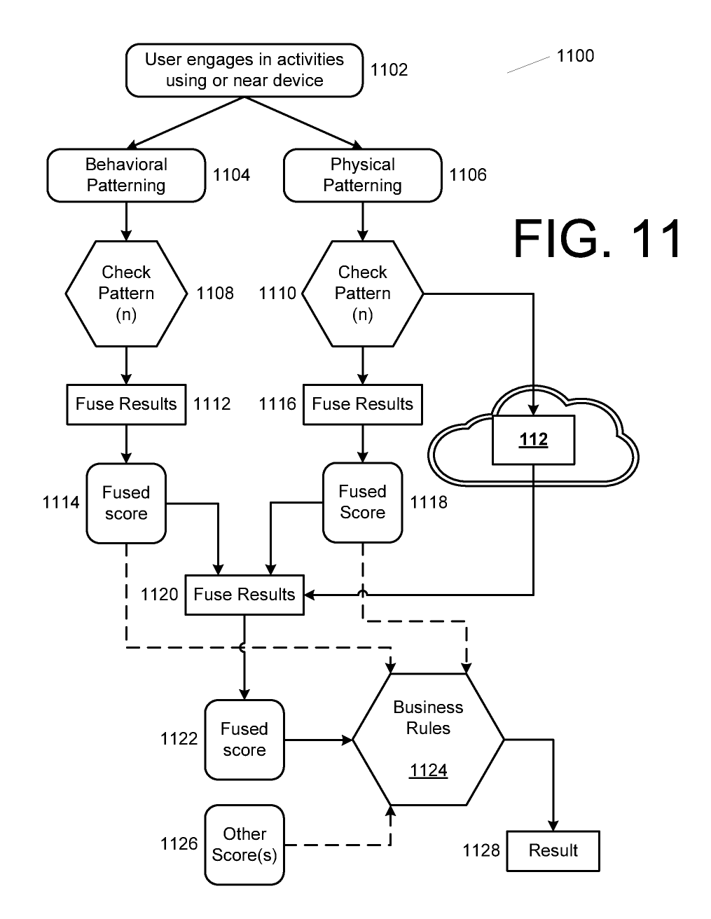

With the foregoing in mind, FIG. 11 illustrates in simplified form, an overview of one example fusion scoring model 1100 suitable for use in the above-described approaches.

The model 1100 involves a user engaging in activities using or near their mobile device 1102. Based upon the user actions and capabilities of their mobile device, behavioral patterning data 1104 and physical patterning data 1106 is collected over time and stored. The collected behavioral patterning data 1104 is also checked 1108 against a compilation of the user's stored behavioral patterning data, and the collected physical patterning data 1106 is similarly checked 1110 against a compilation of the user's stored physical patterning data. As shown in FIG. 11, with this particular model, the user's mobile device has the capability to analyze all of the behavioral data, whereas, in contrast, it only has the capability to analyze some of the physical data. As a result, the data the user's mobile device cannot analyze, is passed to the system 112 for analysis.

The results of the individual behavioral pattern checks are fused 1112 into a single fused behavioral score 1114. Similarly, the results of the physical pattern checks that could be performed on the user's mobile device are fused 1116 into a physical score 1118. The fused behavioral score 1114 and the on-device fused physical score 1118 along with the physical score(s) analyzed by the system 112 and returned to the user's device are then collectively fused 1120 into a single fused score 1122. One or more applicable business rule(s) are then applied to the fused score 1122. The applicable business rule(s) 1124 may be applied solely to this fused score 1122, may optionally (as shown) also take into account any or all of the: behavioral fused score 1114, the physical fused score 1118, and even one or more other fused score(s) 1126 which the system 112 maintains in non-volatile storage, which, as described above, may reflect and one or more of (i) transactions between the user and other payees, (ii) transactions of other payors with the payee of the specific transaction being dealt with, and/or (iii) transactions between other payors and payees having similar characteristics in terms of timing, type or amount(s), (i), (ii) and (iii) individually and collectively being referred to as “external” scores because they entirely reflect information from other than the specific present transaction or value exchange between that payor and payee at that specific time. Application of the business rule(s) 1124 will give a result 1128, typically an “approve” or “deny”, but optionally in some cases some form of “further action required” indication, for the particular transaction event or value exchange.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized to contain the software. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with a processor.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program or data for use by or in connection with an instruction execution system, apparatus, or device. Program code embodied in a computer readable signal medium may be transmitted using any approach including but not limited to wireless, wireline, optical fiber cable, RF, etc., or any combination of the foregoing.

Computer program code for carrying out operations for aspects of the present invention may be written in any combination of one or more programming languages or processor understandable code (operation codes and arguments), including an object oriented programming language such as Java, Smalltalk, C++ or the like and conventional procedural programming languages, such as the “C” programming language or similar programming languages. The program code may execute entirely on one device or partly on multiple devices in a distributed fashion.

To the extent aspects are described with reference to flowchart illustrations. It should be understood that some or all blocks of the flowchart illustrations and/or block diagrams can be implemented by computer program instructions running on a computer or entirely on hardware circuitry. The computer program instructions will be provided to the processor, such that the instructions, which execute via the processor create means for implementing the functions/acts specified in the flowchart and/or block diagram block or blocks.

In addition, the computer program instructions may also be stored in a computer readable medium that can direct a computer, other programmable data processing apparatus, or other devices to function in a particular manner, such that the instructions stored in the computer readable medium combined are an article of manufacture which implements the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products, according to various embodiments of the present invention. In this regard, each block in a flowchart or block diagram may represent a module, segment, or portion of computer code, which comprises one or more instructions executable by one or more processors that implement the specified function(s). It should also be noted that, in some alternative implementations, the functions noted in a block may occur out of the order noted in the figures. For example, two blocks shown in succession may, in fact, be executed substantially concurrently, or the blocks may sometimes be executed in the reverse order, concurrently or in an interleaved fashion, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any and all means or step plus function elements in the claims are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments herein were chosen and described in order to best explain the principles of the invention and its practical application, and to enable others of ordinary skill in the art to understand and practice the invention.

It should be understood that the description (including the figures) is only representative of some illustrative embodiments. For the convenience of the reader, the above description has focused on a representative sample of all possible embodiments, a sample that teaches the principles of the invention. The description has not attempted to exhaustively enumerate all possible variations. That alternate embodiments may not have been presented for a specific portion of the invention, or that further undescribed alternate embodiments may be available for a portion, is not to be considered a disclaimer of those alternate embodiments. One of ordinary skill will appreciate that many of those undescribed embodiments incorporate the same principles of the invention as claimed and others are equivalent.

What is claimed is:

1. A method comprising:
acquiring, over a period of time using at least a first component of a mobile device, first data representing behavior of an individual user;
storing the first data in non-volatile storage;
acquiring, over a period of time using at least a second component of a mobile device, second data representing physical characteristic information relating to the individual user;
storing the second data in the non-volatile storage;
at about a time of a transaction involving the individual user and a payee
i) acquiring current behavioral data for the individual user using the first component,
ii) acquiring current physical characteristic information for the individual user using the second component,
iii) analyzing, using a processor, the current behavioral data relative to the first data to obtain at least one behavioral score,
iv) analyzing, using the processor, the current physical characteristic information relative to the second data to obtain at least one physical score,
v) fusing the at least one behavioral score and at least one physical score to obtain a fused present score,
vi) applying at least one business rule to the fused present score, and
vii) indicating to the payee that the transaction is to be approved or declined based upon a result of the applying in “vi)”.

2. The method of claim 1, wherein the applying includes:
taking into account the at least one physical score.

3. The method of claim 1, wherein the applying includes:
taking into account the at least one behavioral score.

4. The method of claim 3, wherein the applying includes:
taking into account the at least one physical score.

5. The method of claim 1, wherein the applying includes:
taking into account at least one external score.

6. The method of claim 5, further comprising:
taking into account at least one of the at least one physical score or the at least one behavioral score.

7. The method of claim 1, wherein the second component and first component are a same component.

8. A computerized method performed as part of a transaction between a payor and a payee, the method comprising:
receiving user information from a mobile device of the payor reflecting continuous authentication information for the payor;
receiving transaction-related information from a device of a payee reflecting at least details of the transaction;
retrieving from storage, at least one external score;
applying at least one business rule to the user information, the business rule incorporating at least one threshold reflecting an acceptable level of business risk, the transaction-related information and the at least one external score to determine whether the transaction should be approved; and,
if the at least one business rule is satisfied, approving the transaction.

9. The computerized method of claim 8 further comprising:
communicating with an application running on the mobile device of the payor which is configured to perform continuous authentication by collecting information over time relating to at least one of behavioral or biometric characteristics of the user and analyzing that information relative the at least one of (i) current behavioral characteristics of the payor, or (ii) current biometric characteristics of the payor.

10. The computerized method of claim 9 further comprising:
receiving at least some data from the application representing current data obtained via a sensor of the mobile device; and
comparing the at least some data with stored past data reflecting past instances of then-current data obtained via the sensor of the mobile device.

11. The computerized method of claim 9, wherein the method further comprises:
prior to the receiving the user information, providing the application to the payor.

12. The computerized method of claim 8 wherein, when the at least one business rule is satisfied, the method further comprises:
notifying a payment system to effect a value transfer from an account of the payor to an account of the payee.

13. The computerized method of claim 8, wherein the external score specifically reflects two or more of:
(i) other transactions between the payor and other payees at other times,
(ii) transactions of other payors with the payee, or
(iii) transactions, within a specified window of time, having a similarity to the transaction but involving other payors and other payees.

14. A system comprising:
an authorization and analysis unit having
an interface through which the authorization and analysis unit receives continuous authentication data from an application program running on a mobile device of a user reflecting a continuous authentication analysis of the user over time, and
programming, executed by a processor, which implements a probabilistic framework involving analyzing scores based upon (i) the received continuous authentication data, (ii) transaction related data and (iii) payee-related data, in connection with a current transaction between the user and the payee and determines, by applying at least one specified business rule to the scores, whether the transaction should be authorized and, if the transaction should be authorized, to trigger a payment system to effect a value transfer from an account of the user to an account of the payee.

15. The system of claim 14, wherein the continuous authentication data from the application program running on the mobile device of the user includes data relating to behavior of the user obtained via at least one component of the mobile device of the user.

16. The system of claim 14, wherein the continuous authentication data from the application program includes data relating to at least one physical characteristic of the user obtained via at least one component of the mobile device of the user.

17. The system of claim 14, wherein the continuous authentication data from the application program includes biometric data relating to the user obtained via at least one component of the mobile device of the user.

18. The system of claim 14, wherein the authorization and analysis unit functionally comprises:
a mobile access component,
a decision management and data mining & analytics component, and
a security services component.
